(19) United States
(12) Patent Application Publication
(10) Pub. No.: US 2026/0254815 A1
(43) Pub. Date: Aug. 27, 2026

(54) SYSTEM AND METHOD FOR INTEGRATING TERRESTRIAL TV & PAY TV INTO OTT USING QR CODE

(71) Applicant: PT MNC Digital Entertainment Tbk., West Jakarta (ID)

(72) Inventor: Rio ANUGRAH, Depok (ID)

(73) Assignee: PT MNC Digital Entertainment Tbk., West Jakarta (ID)

(21) Appl. No.: 19/536,477

(22) Filed: Feb. 11, 2026

(30) Foreign Application Priority Data
Feb. 24, 2025 (ID) S00202501748

(51) Int. Cl. H04L 9/40; H04N 21/81; H04N 21/84

(52) U.S. Cl. CPC H04L 63/10; H04N 21/812; H04N 21/84

(57) ABSTRACT

Disclosed is The invention discloses a system and method for integrating terrestrial TV and Pay TV broadcasts into an Over-The-Top (OTT) platform using QR Codes. Through real-time QR Code generation containing encrypted URLs, users can instantly access streaming content, digital versions, and supporting materials via smart devices. Such a system may enhance interactivity, may enable monetization through targeted advertisements and premium content, and is equipped with security features, user analytics, and validation mechanisms to ensure reliability and scalability.

### FIELD OF INVENTION

The present invention relates to multimedia content distribution technology, and more particularly to a system for integrating terrestrial TV and pay TV broadcasts into an Over-The-Top (OTT) platform by utilizing QR codes to enhance content accessibility, interactivity, and personalization.

### BACKGROUND OF INVENTION

Conventional terrestrial TV broadcasts have several limitations, including restricted access to additional content, where users often struggle to access supporting materials such as trailers, related articles, or digital versions of the live broadcast. Surveys indicate that 78% of terrestrial TV users are unaware of how to manually access additional content. In addition, the system lacks interactivity and does not provide a direct mechanism for switching from linear broadcasts to interactive digital content. The manual process typically requires users to enter URLs or keywords manually into their OTT devices, which carries a high risk of input errors.

To address this issue, a system that connects terrestrial broadcasts with OTT platforms in real time through an intuitive interface is required. The present invention employs QR codes as a bridge between the two platforms, enabling seamless integration and enhancing the user experience.

Conventional terrestrial TV broadcasts also face limitations in terms of accessibility and interactivity. Users often encounter difficulties when attempting to access additional content such as trailers, articles, or digital versions of broadcasts. Furthermore, transitioning to digital platforms typically requires manual input, which is prone to errors. Several previous attempts have been made to address these issues; however, technical or functional weaknesses still remain. At present, there have been some innovations related to the integration of terrestrial TV and pay TV broadcasts with Over-The-Top (OTT) platforms through the use of QR codes to enhance content accessibility, interactivity, and personalization. One such example is U.S. Patent No. 9,876,543 B2, titled System for Linking Broadcast Content to Online Resources Using Dynamic Barcodes, published in 2018. This patent discloses the use of dynamic barcodes that update every 30 seconds to direct users to websites related to the broadcast. However, the system has limitations, including the limited data capacity of barcodes, lack of encryption support, and the need for a dedicated application to scan the barcodes. Another example is an IEEE publication titled Interactive TV Services via QR Code Integration, published in 2020, which describes the use of static QR codes displayed on TV screens to direct users to FAQ pages or program schedules. Its main drawback is that the QR codes are not integrated with metadata in real time, making the accessed content less relevant to the context of the broadcast.

Another innovation is a TV companion application platform developed by XYZ Corp., published in 2021, which utilizes NFC technology to connect smartphones to Smart TVs in order to access additional content. However, this approach requires special NFC-enabled devices and a very close scanning range (<5 cm), making it impractical for widespread public use. Another related patent is CN 110123456 A, published in 2019, titled Method for Delivering Targeted Ads via QR Codes in Broadcast Streams, which discloses the insertion of pre-rendered QR codes into TV broadcasts to direct users to targeted advertisements. The drawback of this patent is that the QR codes are not generated in real time, making it impossible to dynamically adapt to changes in broadcast content.

However, there is currently no existing solution addressing the innovation in multimedia content distribution. Specifically, a system for integrating terrestrial TV and pay TV broadcasts into Over-The-Top (OTT) platforms through the use of QR codes to enhance content accessibility, interactivity, and personalization, wherein the QR codes are generated in real time (<0.5 seconds) using live metadata directly from the broadcast encoder. This enables rapid response to content changes based on broadcast metadata (such as title, airtime, and specific URLs), ensuring that OTT content remains synchronized at all times. The system also supports high data capacity, encrypted URLs, and compatibility with standard scanning applications, allowing QR codes to be scanned from a distance (up to 3 meters) and be accessible across all smart devices.

### BRIEF DESCRIPTION OF THE INVENTION

The primary objective of this invention is to provide a multimedia content distribution system, specifically a system for integrating terrestrial TV and pay TV broadcasts into Over-The-Top (OTT) platforms through the use of QR codes to enhance content accessibility, interactivity, and personalization. This system generates QR codes in real time by combining real-time responsiveness, data security, and deep integration with OTT platforms. The invention also offers solutions such as URL encryption with authentication token to prevent spoofing, synchronization between broadcast metadata and OTT content, and user analytics mechanisms based on machine learning or AI to enable content personalization.

Accordingly, this invention not only overcomes the limitations of previous systems but also introduces and provides an innovation that has not been covered by any prior inventions or existing technologies.

### BRIEF DESCRIPTION OF THE DRAWING

The embodiment of the present invention is further described with reference to the accompanying drawing, in which:

FIG. 1 is a flow diagram representing the system according to the present invention.

### DETAILED DESCRIPTION OF THE INVENTION

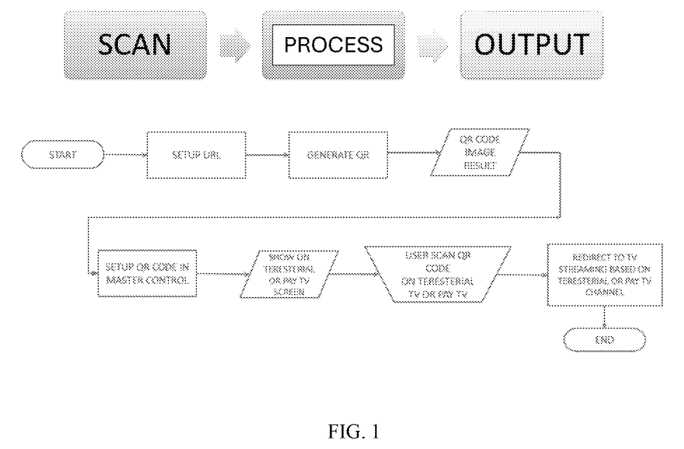

An exemplary embodiment of the present invention will be described in more detail with reference to the attached drawing. Although an example of the invention is illustrated in the accompanying figure, it should be understood that the invention may be implemented in various forms and is not limited to the embodiment described herein. Rather, this embodiment is provided to enable a more comprehensive understanding of the invention and to fully convey the scope of the invention to those skilled in the art. Referring to FIG. 1, which illustrates a flow diagram of the process according to the present invention, the steps are as follows:
1. START: System initialization.
2. SETUP URL: The process of collecting broadcast metadata and converting it into a URL.
3. GENERATE QR: Creating and generating a QR code from the URL.
4. QR CODE IMAGE RESULT: The generated QR code is ready for display.
5. SETUP QR CODE IN MCR: Integrating the QR code into the broadcast signal via the Master Control Room (MCR).
6. DISPLAY ON TV SCREEN: Displaying the QR code on the user’s television screen.
7. USER SCANS QR CODE ON TV: The user scans the QR code displayed on the TV screen.
8. REDIRECT TO TV STREAMING: Redirecting the user to the OTT platform for streaming.
9. END: Completion of the integration cycle. Referring to FIG. 1, the system of the present invention further comprises three main components:

Metadata Generator Module, which is integrated with the terrestrial broadcast encoder to collect data such as program title, airtime, content description, OTT URL, and a unique content identifier (ID).

QR Code Generation Engine, which converts the metadata into a dynamic, encrypted URL (HTTPS) for security purposes, and then generates a QR code using the QR Code Model 2 algorithm (which supports high data capacity and 15% error correction tolerance).

OTT Platform, which provides an API to receive URL-based requests, match the metadata with available content (e.g., live streaming, video-on-demand, targeted ads), and manage user analytics. Still referring to FIG. 1, the operational flow of the system according to the invention includes real-time QR code generation, wherein the metadata is sent to a central server via RTMP (Real-Time Messaging Protocol). The server then converts the metadata into a URL with encrypted parameters, after which a QR code is generated and overlaid on the TV broadcast within less than 0.5 seconds, ensuring perfect synchronization.

Still referring to FIG. 1, in the flow diagram at the user scanning step, the QR code is scanned using a standard scanning application (e.g., Google Lens, QR Code Reader) or a dedicated application provided by the content provider. The application then parses the URL and opens the corresponding OTT page either in a browser or in a native app (if installed). If there is no internet connection at the time of scanning, the system stores the URL in the cache until the connection is restored.

Still referring to FIG. 1, the integration system according to the present invention is integrated with the OTT platform, wherein the OTT platform validates the URL using an authentication token to prevent unauthorized access. Once validated, the corresponding content is displayed, including live streaming of TV broadcasts with adaptive quality (HD/4K), additional content (such as trailers, behind-the-scenes features, and articles). The integration system also includes monetization options such as targeted advertising, premium subscriptions, or pay-per-view purchases. Additionally, user data (such as the number of scans, viewing duration, and preferences) is recorded for analytics and content personalization purposes.

Furthermore, still referring to FIG. 1, during the Setup URL process (Step 2 in FIG. 1), the metadata about the broadcast content (e.g., program title, unique ID, airtime, OTT URL) is collected in real time from the terrestrial broadcast encoder or the content management system (MCR). The collected metadata is then converted into an encrypted URL, wherein the metadata is transformed into a dynamic URL with encrypted parameters using the AES-256 algorithm to ensure security. Still referring to FIG. 1, the QR Code Generation process (Steps 3–4 in FIG. 1) involves generating a QR code from the encrypted URL. This is processed by the QR Code generation engine using the QR Code Model 2 standard, which supports up to 4,296 characters and offers 15% error correction tolerance. Furthermore, still referring to FIG. 1, the display optimization of the QR Code involves rendering the code in high resolution (at least 300 DPI) and formatting it as a transparent overlay to ensure visibility on the TV screen.

Still referring to FIG. 1, the placement of the QR Code in the TV Broadcast (Steps 5–6 in FIG. 1) is integrated with the Master Control Room (MCR), wherein the QR Code is inserted into the broadcast signal through the MCR system using graphics overlay techniques (e.g., DVE-2D). Subsequently, for time synchronization, the QR Code is displayed on the TV screen within ≤0.5 seconds after the metadata is received, in accordance with the broadcast progress (e.g., appearing at the corner of the screen during advertisements or program segmentation).

Still referring to FIG. 1, during the scanning by the User (Step 7 in FIG. 1), the user's scanning application scans the QR Code using either a standard application (such as Google Lens or a smartphone camera) or a dedicated application provided by the content provider. Subsequently, in the decryption process, the encrypted URL is decrypted by the OTT server to validate the authenticity of the request, and if any manipulation is detected, the system will block access.

Still referring to FIG. 1, in the redirection to the OTT platform (Step 8 in FIG. 1), token validation is performed, wherein the OTT platform checks the authentication token in the URL to ensure the request originates from a legitimate source. The platform then delivers adaptive content based on the received metadata, enabling the OTT platform to stream the live TV broadcast in adaptive quality (ranging from HD to 4K), synchronized with the terrestrial broadcast. This stream also includes additional content such as trailers, interactive polls, or articles related to the program, along with monetization features: targeted advertisements or premium subscription options.

Still referring to FIG. 1, in the analytics and tracking section (not shown in the figure), the data recording process logs metrics such as the number of scans, user location, viewing duration, and content preferences. Machine learning or AI is used to analyze the data and enhance content personalization, such as recommending similar programs based on viewing history.

Still referring to FIG. 1, in the final process (Step 9 in FIG. 1) after the user finishes accessing the content, the OTT system sends a notification to the user’s device and ends the session and automatically update the metadata for the next broadcast, to ensure the QR code remains relevant.

The following explains how the integration system of terrestrial TV and pay TV broadcasts for Over-The-Top (OTT) platform works through the use of QR code wherein the step of transforming TV terrestrial broadcast to OTT platform, the user interface on the OTT platform displays interactive buttons for sharing content on social media after scanning the QR Code, a control panel for content providers to manage metadata, monetization, and analytics with a process of collecting broadcast metadata in real-time via RTMP (Real-Time Messaging Protocol) from the broadcast encoder or MCR; then converting metadata into encrypted dynamic URL with AES-256 algorithm; and then generating a QR Code from the said URL using a QR Code Model 2 standard by inserting a QR Code into the TV broadcast signal through a graphics overlay system in the MCR then validating an authentication token in the URL after scanning by the user to present adaptive content on the OTT platform according to the metadata parameter and user preference in the form of live streaming of the TV broadcast with real-time synchronization to the terrestrial broadcast; displaying targeted ads based on geographic location or user demographic; and offering premium subscription or pay-per-view options through integration with digital payment gateway. Scan QR Code by a user comprises URL description by OTT server to verify the token’s authenticity, storing URL to the user’s device cache if there is no internet connection, with an automatic redirection once the connection becomes available.

Specific embodiments of this invention have been described. However, skilled person in the art will recognize that various modifications and changes may be made without departing from the scope of the invention. Therefore, the specification and drawings are to be regarded as illustrative rather than restrictive, and all such modifications are intended to be included within the scope of the invention.

1. A system for integrating terrestrial TV and pay TV broadcasts with an Over-The-Top (OTT) platform using a QR Code, comprising:
a Metadata Generator Module integrated with a terrestrial broadcast encoder or a content management system to collect data in real-time, wherein the data comprises at least one of program title, airtime, content description, a unique content ID, and URL platform OTT;
a QR Code Generation Engine configured to convert the metadata into an encrypted URL using AES-256 algorithm and configured to generate a QR code based on QR Code Model 2 standard with 15% error correction tolerance;
an OTT platform configured to provide an API for validating an authentication token in the URL, to display adaptive live streaming content, additional content, or monetization options, and to record user analytics data; and
a graphics overlay system configured to display the QR Code as a dynamic on-screen element in the TV broadcast, with time synchronization of ≤0.5 seconds.

2. The system of claim 1, wherein the encrypted URL contains:
unique parameters including a time-based authentication token to prevent unauthorized access;
a content ID linked to the OTT platform’s database; and
additional metadata for HD and 4K streaming quality and language preferences.

3. The system of claim 1, wherein the OTT platform employs a recommendation engine based on machine learning or AI to personalize additional content based on the user's scanning history and preferences.

4. The system of claim 3, wherein the additional content comprises at least one of trailers, articles, and advertisements.

5. The system of claim 1, wherein the QR Code is displayed as a transparent overlay in a corner of the TV screen.

6. The system of claim 5, wherein the QR Code is displayed during a program segmentation, an advertisement, or a specific interaction as determined by the broadcaster.
